(19) United States
(12) Patent Application Publication
(10) Pub. No.: US 2019/0031540 A1
(43) Pub. Date: Jan. 31, 2019

(54) DRY, GRANULAR COMPOSITION AND METHOD FOR WATER CONDITIONING

(71) Applicant: Silk Water Solutions Inc., Langley (CA)

(72) Inventor: Colin Frank Taylor, Surrey (CA)

(21) Appl. No.: 15/665,290

(22) Filed: Jul. 31, 2017

(51) Int. Cl. C02F 1/68; C02F 5/10; C02F 5/08

(52) U.S. Cl. CPC C02F 1/68; C02F 2103/42; C02F 5/086; C02F 5/105

(57) ABSTRACT

A water conditioning composition includes at least one gluconate compound; at least one carbonate compound; one or more compounds which form a phosphate buffer when dissolved in water; and a filler material, where the composition does not include a non-ionic preservative. For example, the composition can include 6 to 12 wt. % of the at least one gluconate compound; 35 to 50 wt. % of the at least one carbonate compound; 10 to 30 wt. % of the one or more compounds which form the phosphate buffer when dissolved in water; and 20 to 40 wt. % of the filler material.

### FIELD OF THE INVENTION

The present invention is directed to the area of water conditioning. The present invention is also directed to compositions and methods for water conditioning.

### BACKGROUND OF THE INVENTION

Pools, spas, and hot tubs require regular chemical maintenance of water for hygiene and to prevent, inhibit, or reduce the buildup of stains, mineral deposits, biofilms (including bacterial growths), and the like. These chemical treatments, however, can dry or irritate the skin of users, produce chemical odors, and produce other deposits on the filters and walls of the pool, spa, or hot tub.

It is desirable to provide water conditioning treatments that reduce or prevent dry, itching, or irritated skin, reduce or prevent chemical odors, or reduce or prevent deposits on the filters or other portions of the pool, spa, or hot tub. Preferably, a water conditioning treatment performs two or more of these functions. In addition, it is desirable that the water conditioning treatment be performed on a weekly, or less frequent basis, and that the water be suitable for use soon after treatment.

### SUMMARY OF THE INVENTION

One embodiment is a dry, granular composition suitable for conditioning water of a spa, hot tub, or pool, that includes at least one gluconate compound; at least one carbonate compound; one or more compounds which form a phosphate buffer when dissolved in water; and a filler material. Preferably, the composition does not comprise a non-ionic preservative.

In at least some embodiments, the at least one gluconate compound is selected from sodium gluconate, potassium gluconate, or any combination thereof. In at least some embodiments, the at least one carbonate compound is selected from sodium carbonate, sodium bicarbonate, potassium carbonate, or any combination thereof. In at least some embodiments, the one or more compounds which form the phosphate buffer when dissolved in water includes at least two of disodium phosphate anhydrate, monopotassium phosphate, or trisodium phosphate. In at least some embodiments, the filler material is a neutral salt.

In at least some embodiments, the at least one gluconate compound is sodium gluconate, the at least one carbonate compound is sodium carbonate, one or more compounds which form the phosphate buffer when dissolved in water are disodium phosphate anhydrate and monopotassium phosphate, and the filler material is sodium chloride. In at least some embodiments, the composition consists essentially of 6 to 12 wt. % of the at least one gluconate compound; 35 to 50 wt. % of the at least one carbonate compound; 10 to 30 wt. % of the one or more compounds which form the phosphate buffer when dissolved in water; and 20 to 40 wt. % of the filler material. In at least some embodiments, the composition does not contain calcium.

Another embodiment is a dry, granular composition suitable for conditioning water of a spa, hot tub, or pool, consisting of at least one gluconate compound; at least one carbonate compound; one or more compounds which form a phosphate buffer when dissolved in water; and a neutral salt as a filler material. Preferably, the composition does not contain a non-ionic preservative.

In at least some embodiments, the gluconate compound is selected from sodium gluconate, potassium gluconate, or any combination thereof. In at least some embodiments, the carbonate compound is selected from sodium carbonate, sodium bicarbonate, potassium carbonate, or any combination thereof. In at least some embodiments, the phosphate buffer includes at least two of disodium phosphate anhydrate, monopotassium phosphate, or trisodium phosphate. In at least some embodiments, the neutral salt is sodium chloride or sodium sulfate. In at least some embodiments, the at least one gluconate compound is sodium gluconate, the at least one carbonate compound is sodium carbonate, one or more compounds which form the phosphate buffer when dissolved in water are disodium phosphate anhydrate and monopotassium phosphate, and the neutral salt is sodium chloride.

Yet another embodiment is a method for treating water of a pool, spa, or hot tub for bathing. The method includes providing water in the pool, spa, or hot tub; adding any of the compositions described above to the water to condition the water; and bathing in the treated water within the pool, spa, or hot tub.

### DETAILED DESCRIPTION OF THE PREFERRED EMBODIMENT

The present invention is directed to the area of water conditioning. The present invention is also directed to compositions and methods for water conditioning.

In at least some embodiments, a dry, granular composition for water conditioning includes at least one gluconate compound, at least one carbonate compound, and compounds which when added to water form a phosphate buffer. In at least some embodiments, the composition for water conditioning consists essentially of at least one gluconate compound, at least one carbonate compound, compounds which when added to water form a phosphate buffer, and, optionally, a filler material. It will be understood, however, that other non-essential components, such as dyes, scents, or the like, which do not contribute to the conditioning of water can also be included in the composition. In at least some embodiments, the composition for water conditioning consists of a gluconate compound, a carbonate compound, compounds which when added to water form a phosphate buffer, and, optionally, a filler material. It will be understood that the composition may also eliminate one or more of these components. For example, other embodiments may omit the gluconate or the carbonate or the phosphate buffer or the filler material or any combination thereof.

The composition is in the form of a dry, granular material. The composition is preferably stored in this dry form until it is to be used for conditioning water. In use, this dry composition is added to the water of the pool, spa, or hot tub where the composition dissolves to condition that water in the pool, spa, or hot tub. In some embodiments, the composition is placed in a water-soluble pod or pouch. In other embodiments, the composition is placed in a container or pouch that is opened by the user. In yet other embodiments, the composition can be formed into a pellet or other shape.

Any suitable gluconate compound can be used. Examples of suitable gluconate compounds include sodium gluconate, potassium gluconate, gluconic acid, or any combination thereof. Although these gluconate compounds are usually derived from D-gluconic acid, it will be understood that compounds derived from L-gluconic acid can also be used. In at least some embodiments, the gluconate compound is an alkali metal gluconate and is preferably sodium gluconate.

The gluconate compound can act as a chelating or sequestering agent to coordinate or bind with metal ions. In at least some embodiments, the gluconate compound chelates or sequesters metal ions, such as iron or copper ions, within the water of the pool, spa, or hot tub. In at least some embodiments, the gluconate compound, together with other components of the composition, may produce a “softness” of the water arising, at least in part, due to the chelating or sequestering of metal ions, such as iron or copper ions.

Any suitable carbonate can be used. Examples of suitable carbonate compounds include sodium carbonate, sodium bicarbonate, potassium carbonate, or any combination thereof. In at least some embodiments, the carbonate compound is an alkali metal carbonate and is preferably sodium carbonate. In at least some embodiments, the composition does not include calcium carbonate.

The carbonate compound can act as a water softening agent to coordinate or bind with metal ions such as calcium, magnesium, and the like. In at least some embodiments, the carbonate compound can also act as a buffering agent. The carbonate compound may also reduce or inhibit the corrosive effects of chlorine or bromine added to the water of the pool, spa, or hot tub.

Any suitable materials that form a phosphate buffer can be used. For example, the phosphate buffer can be formed using disodium phosphate anhydrate and monopotassium phosphate. Other phosphate materials can be used, such as, for example, trisodium phosphate. In some embodiments, the ratio, by weight, of disodium phosphate anhydrate to monosodium phosphate is in the range of 0.5 to 2.5 or in the range 0.8 to 1.8 or in the range of 0.9 to 1.3 or equal to 1. In at least some embodiments, upon dissolving the composition in water, the phosphate buffer provides buffering in a pH range of at least 7-8. In at least some embodiments, the phosphate buffer and the carbonate compound provide buffering in a pH range from 7 to 8 or 7 to 9.

Any suitable filler material, such as a neutral salt, may be used. In at least some embodiments, the filler is a neutral salt to reduce the effect of pH increase arising from the other components of the composition. Preferably, the filler is neutral and does not contribute to or interact with the carbonate or phosphate when in solution. Examples of suitable fillers include, but are not limited to, sodium chloride, sodium sulfate, or the like. In at least some embodiments, the filler material is selected to reduce or eliminate granular separation or to facilitate production of a homogenous granular mixture or any combination of these benefits. As an example, the size of the granules may be in the range of 0.3 to 0.9 mm in diameter.

In at least some embodiments, the composition does not include a metasilicate compound. In at least some embodiments, the composition does not include a sulfate compound. In at least some embodiments, the composition does not include a silver compound. In at least some embodiments, the composition does not include calcium. In at least some embodiments, the composition does not include a preservative, such as, for example, a non-ionic preservative.

In at least some embodiments, the composition includes 4 to 15 wt. % gluconate compound; 30 to 60 wt. % carbonate compound; 6 to 35 wt. % of compounds that form a phosphate buffer when dissolved in water, and 15 to 60 wt. % filler. In at least some embodiments, the composition includes 6 to 12 wt. % gluconate compound; 35 to 50 wt. % carbonate compound; 10 to 30 wt. % of compounds that form a phosphate buffer when dissolved in water, and 20 to 40 wt. % filler.

In at least some embodiments, the composition includes a ratio, by weight, of 1 part gluconate compound to 4 to 10 parts (or 5 to 7 parts) carbonate compound. In at least some embodiments, the composition includes a ratio, by weight, of 1 part gluconate compound to 0.5 to 3 parts (or 1.3 to 2.5 parts) of compounds that form a phosphate buffer when dissolved in water.

The composition can include other non-essential components that do not contribute to the water conditioning. Such components can include dyes or scents.

The composition can be formed using any suitable process. In some embodiments, the components mixed together in their granular forms. Preferably, the mixing process yields a homogenous blend. Lumps or clusters of granular chemical are preferably avoided

In at least some embodiments, 1 ounce (about 28 grams) of the dry, granular composition can be used to treat 450 gallons (about 1700 liters) of water once per week. Increased frequency of addition at the same rate can increase the sensory feel of softness and olfactory freshness of the treated water. Other treatment amounts can be used to treat water.

In one embodiment, a method of using the composition includes placing new or cleaned filters into the pool, spa, or hot tub; filling the pool, spa, or hot tub with water; heating the water to a desired temperature; adding chlorine or bromine to the water; and balancing the Total Alkalinity. Preferably, the water the water is within normal usage limits: pH 7.2 to 7.5; Total Alkalinity 80 to 120 ppm; Total Hardness 180 to 250 ppm; and Chlorine or Bromine 2 to 5 ppm; which can be determined by using an appropriate test strip. The water conditioning composition as described herein can then be added to the water.

For many conventional water conditioners, a user should wait at least one day after adding the chlorine or bromine before adding the water condition. In at least some embodiments, the water conditioning composition described herein can be added within 10 minutes (or within 30 minutes or within 1 hour) of adding the chlorine or bromine. In at least some embodiments, the pool, spa, or hot tub can be used within 10 minutes or 30 minutes after adding the water conditioning composition. The composition is generally compatible with chlorine, bromine, or biguanidine and can be added to the water at any time.

### Examples

One example of a composition included 8.00 wt. % sodium gluconate, 45.00 wt. % sodium carbonate; 6.00 wt. % disodium phosphate anhydrate; 6.67 wt. % monopotassium phosphate; and 34.33 wt. % sodium chloride.

2.00 grams of the composition in 150 ml of water produced a pH of 10.2 to 10.6; free alkalinity (as Na₂O) of 7.50 to 8.90, and total alkalinity (as Na₂O) of 18.2 to 21.8.

The above specification, examples and data provide a description of the manufacture and use of the composition of the invention. While the preferred embodiment of the invention has been illustrated and described, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A dry, granular composition suitable for conditioning water of a spa, hot tub, or pool, comprises:
at least one gluconate compound;
at least one carbonate compound;
one or more compounds which form a phosphate buffer when dissolved in water; and
a filler material,
wherein the composition does not comprise a non-ionic preservative.

2. The composition of claim 1, wherein the at least one gluconate compound is selected from sodium gluconate, potassium gluconate, or any combination thereof.

3. The composition of claim 1, wherein the at least one carbonate compound is selected from sodium carbonate, sodium bicarbonate, potassium carbonate, or any combination thereof.

4. The composition of claim 1, wherein the one or more compounds which form the phosphate buffer when dissolved in water includes at least two of disodium phosphate anhydrate, monopotassium phosphate, or trisodium phosphate.

5. The composition of claim 1, wherein the filler material is a neutral salt.

6. The composition of claim 1, wherein the at least one gluconate compound is sodium gluconate, the at least one carbonate compound is sodium carbonate, one or more compounds which form the phosphate buffer when dissolved in water are disodium phosphate anhydrate and monopotassium phosphate, and the filler material is sodium chloride.

7. The composition of claim 1, wherein the composition consists essentially of 6 to 12 wt. % of the at least one gluconate compound; 35 to 50 wt. % of the at least one carbonate compound; 10 to 30 wt. % of the one or more compounds which form the phosphate buffer when dissolved in water; and 20 to 40 wt. % of the filler material.

8. The composition of claim 1, wherein the composition does not contain calcium.

9. A dry, granular composition suitable for conditioning water of a spa, hot tub, or pool, consisting of:
at least one gluconate compound;
at least one carbonate compound;
one or more compounds which form a phosphate buffer when dissolved in water; and
a neutral salt as a filler material,
wherein the composition does not contain a non-ionic preservative.

10. The composition of claim 9, wherein the gluconate compound is selected from sodium gluconate, potassium gluconate, or any combination thereof.

11. The composition of claim 9, wherein the carbonate compound is selected from sodium carbonate, sodium bicarbonate, potassium carbonate, or any combination thereof.

12. The composition of claim 9, wherein the phosphate buffer includes at least two of disodium phosphate anhydrate, monopotassium phosphate, or trisodium phosphate.

13. The composition of claim 9, wherein the neutral salt is sodium chloride or sodium sulfate.

14. The composition of claim 9, wherein the at least one gluconate compound is sodium gluconate, the at least one carbonate compound is sodium carbonate, one or more compounds which form the phosphate buffer when dissolved in water are disodium phosphate anhydrate and monopotassium phosphate, and the neutral salt is sodium chloride.

15. A method for treating water of a pool, spa, or hot tub for bathing, the method comprising:
providing water in the pool, spa, or hot tub;
adding the composition of claim 1 to the water to condition the water; and
bathing in the treated water within the pool, spa, or hot tub.

16. The method of claim 15, wherein the gluconate compound is selected from sodium gluconate, potassium gluconate, or any combination thereof.

17. The method of claim 15, wherein the carbonate compound is selected from sodium carbonate, sodium bicarbonate, potassium carbonate, or any combination thereof.

18. The method of claim 15, wherein the phosphate buffer includes at least two of disodium phosphate anhydrate, monopotassium phosphate, or trisodium phosphate.

19. The method of claim 15, wherein the filler material is a neutral salt.

20. A method for treating water of a pool, spa, or hot tub for bathing, the method comprising:
providing water in the pool, spa, or hot tub;
adding the composition of claim 9 to the water to condition the water; and
bathing in the treated water within the pool, spa, or hot tub.
